(19) United States
(12) Patent Application Publication
(10) Pub. No.: US 2026/0179498 A1
(43) Pub. Date: Jun. 25, 2026

(54) System and Method for Training Visual-Spatial Cognitive Abilities

(71) Applicant: National Cheng Kung University, Tainan City (TW)

(72) Inventors: Cheng-Ta YANG, Tainan City (TW); Shu-Hsuan FENG, Tainan City (TW); Ming-Hui CHENG, Tainan City (TW); Kun-Tang CHANG, Tainan City (TW); Hao-Lun FU, Tainan City (TW)

(21) Appl. No.: 19/069,981

(22) Filed: Mar. 4, 2025

(30) Foreign Application Priority Data
Dec. 19, 2024 (TW) 113149536

(51) Int. Cl. G09B 5/02; G06F 3/04815; G06F 3/04845

(52) U.S. Cl. CPC G09B 5/02; G06F 3/04815; G06F 3/04845

(57) ABSTRACT

A system for training visual-spatial cognitive abilities includes a storing unit storing plural main scripts and 3D graphic elements which are relevant to spatial cognition abilities. A processing may extract one of the main scripts and at least one of the 3D graphic elements to generate a training task and execute the training task within a preset time. A display interface displays the 3D graphic element based on the conducted training task.

### CROSS REFERENCE

This application claims priority to Taiwan patent application No. 113149536 filed on Dec. 19, 2024, titled as “System and Method for Training Visual-Spatial Cognitive Abilities”, all of which are incorporated by reference herein in its entirety.

### FIELD OF THE INVENTION

This present invention relates to the field of system for training student, particularly relates to a system and a method for training visual-spatial cognitive abilities.

### BACKGROUND OF THE INVENTION

Visual-spatial cognitive ability is an ability to well form, preserve, search and convert graphics, which is a key to learn mathematics and geometry. Today, students learn mathematics and geometry through independent or separating concepts resulting from the analysis or segmentation done by education experts, which lacks fundamental learning and training on visual-spatial cognitive ability and results in restriction on learning due to failure in overcoming difficulties.

### SUMMARY OF THE INVENTION

A system for training visual-spatial cognitive abilities and computer executive steps are provided to execute a training task relevant to visual-spatial cognitive abilities through a head-mounted display device. The training task is configured to cultivate and train spatial cognitive abilities for students in high grades of primary school or students in junior high school. These spatial cognitive abilities include abilities to generate, maintain, search and convert space.

A system for training visual-spatial cognitive abilities and computer executive steps are provided to execute a training task relevant to visual-spatial cognitive abilities through a head-mounted display device. The training task may be used to evaluate a participant's visual-spatial cognitive abilities.

Accordingly, a computer readable storage media, containing computer executable program to execute following steps including: providing multiple training tasks each of which includes a main script and at least one three-dimensional graphic element, wherein the main script is relevant to training of spatial cognitive abilities; executing one of the training tasks according to a selection command; displaying the three-dimensional graphic element of the executed training task on a virtual reality display interface; and ending the executed training task according to a preset time.

Accordingly, a system for training visual-spatial cognitive abilities, including: a storage unit storing multiple main scripts and multiple three-dimensional graphic elements, wherein the main scripts are relevant to training of spatial cognitive abilities; a processing unit extracting one of the main scripts and at least one of the three-dimensional graphic elements to generate a training task, and executing the training task within a preset time; and a display interface displaying the three-dimensional graphic element of the executed training task.

Accordingly, a system, including: memory including machine-readable instructions; and one or more processors configured, in response to executing the machine-readable instructions, to perform operations including: providing multiple training tasks each of which includes a main script and at least one three-dimensional graphic element, wherein the main script is relevant to training of spatial cognitive abilities; executing one of the training tasks according to a selection command; and displaying the three-dimensional graphic element of the executed training task on a virtual reality display interface.

In one embodiment, the computer readable storage media or the system further includes storing a training record in response to the executed training task.

In one embodiment, the computer readable storage media or the system further includes changing at least one of an angle and a position of the three-dimensional graphic element displayed on the virtual reality display interface.

In one embodiment, the step of providing further provides an auxiliary script of any one of the training tasks to modify the one training task.

In one embodiment, the processing unit further includes retrieving a training record in response to the executed training task, and the storage unit further comprises storing the training record.

In one embodiment, the storage unit further includes storing at least one auxiliary script, and the processing unit further comprises extracting the auxiliary script to modify the training task.

In one embodiment, the training task comprises at least one of a puzzle task, a memorization task, a search task and a mental rotation task.

In one embodiment, the processing unit further includes, based on a test result relevant to spatial cognitive abilities, extracting one of the main scripts and at least one of the graphic elements to generate the training task.

In one embodiment, an input interface is electrically coupled to the processing unit, and the processing unit receives a selection command from the input interface to execute the training task.

In one embodiment, an input interface is electrically coupled to the processing unit, and the processing unit receives an input command to change at least one of an angle and a position of the three-dimensional graphic element displayed on the display interface.

In one embodiment, the system includes a head-mounted display device.

In one embodiment, the system includes a head-mounted display device and a computer coupled to each other.

### BRIEF DESCRIPTION OF THE DRAWINGS

FIG. 1 is a schematic block diagram illustrating a first example of application with a system for training visual-spatial cognitive abilities in accordance with the present invention.

FIG. 2 is a schematical flowchart diagram illustrating a training task implemented by the system for training visual-spatial cognitive abilities in accordance with the present invention.

FIG. 3 is a schematical diagram illustrating a screen from the execution of the training task in FIG. 2.

FIG. 4 is a schematical diagram illustrating a screen from the execution of the training task in FIG. 2.

FIG. 5 is a schematical flowchart diagram illustrating a training task implemented by the system for training visual-spatial cognitive abilities in accordance with the present invention.

FIG. 6 is a schematical diagram illustrating in-sequence screens from the execution of the training task in FIG. 5.

FIG. 7 is a schematical flowchart diagram illustrating a training task implemented by the system for training visual-spatial cognitive abilities in accordance with the present invention.

FIG. 8 is a schematical diagram illustrating a screen from the execution of the training task in FIG. 7.

FIG. 9 is a schematical diagram illustrating a screen from the execution of the training task in FIG. 7.

FIG. 10 is a schematical flowchart diagram illustrating a training task implemented by the system for training visual-spatial cognitive abilities in accordance with the present invention.

FIG. 11 is a schematical diagram illustrating a screen from the execution of the training task in FIG. 10.

FIG. 12 is a schematical diagram illustrating a screen from the execution of the training task in FIG. 10.

FIG. 13 is a schematical flowchart diagram illustrating the system for training visual-spatial cognitive abilities in accordance with the present invention.

FIG. 14 is a schematically systemic block diagram illustrating the system for training visual-spatial cognitive abilities in accordance with the present invention.

FIG. 15 is a schematical flowchart diagram illustrating a training task implemented by the system for training visual-spatial cognitive abilities in accordance with the present invention.

FIG. 16 is a schematical diagram illustrating a screen from the execution of the training task in FIG. 15.

FIG. 17 is a schematical diagram illustrating a screen from the execution of the training task in FIG. 15.

### DETAILED DESCRIPTION OF THE PREFERRED EMBODIMENT

In the present invention, a participant mainly may be a student at the age of primary school or junior high school, but not restricted to, or anyone who would like to enhance or know own visual-spatial cognitive abilities.

In the present invention, an input interface provides the participant with an interface for inputting controls. For example, a handheld remote interacts, in a wireless way, with the system for training visual-spatial cognitive abilities. A control member, such as a control key or a button shown in 2D or 3D visual space for presenting the system for training visual-spatial cognitive abilities of the present invention, may be as the interface for inputting controls of the present invention. The control key or the button may be operated by the participant with another remote or touch panel to input a control command or interact with graphic elements.

In the present invention, the system for training visual-spatial cognitive abilities at least includes some training tasks each of which is relevant to index of spatial ability and at least a graphic element used as a fundamental element for each training task. Each graphic element is of a fixed geometric shape and three dimensions, and may be visually shown with colors, gray scales or lines in a 2D or 3D scene. In one embodiment, these training tasks include a puzzle task, a memorization task, a search task and a mental rotation task or at least one of them. The puzzle task provides multiple graphic elements and includes a mission of a target graphic to be completed. The memorization task presents multiple graphic elements and includes a mission to determine whether any later graphic is one of the graphic elements that have been shown earlier or not. The search task may present a target graphic element in the first time and then multiple graphic elements in the second time and include a mission to determine whether the target graphic element is in the multiple graphic elements. The mental rotation task first presents multiple graphic elements and then other multiple graphic elements for a mission to determine whether they are identical or not. Furthermore, each training task may have a preset time (eg. It's time) to end the current execution.

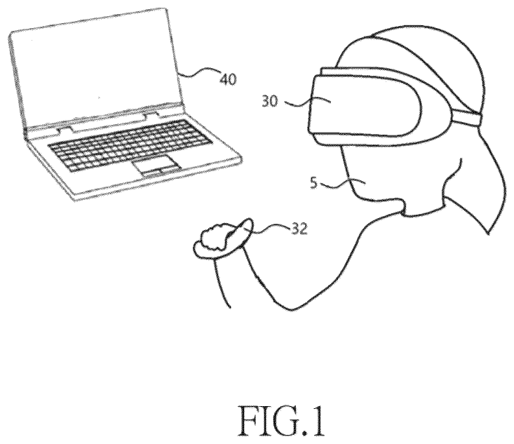

FIG. 1 is a schematic block diagram illustrating a first example of application with a system for training visual-spatial cognitive abilities in accordance with the present invention. Please refer to FIG. 1, a head-mounted display device 30 may execute the training tasks from the system for training visual-spatial cognitive abilities in the present invention and be equipped with a handheld remote device 32 as an input interface. The head-mounted display device 30 includes one or more calculating processors, memories and corresponding circuits, and the training tasks may be stored and executed in the head-mounted display device 30. An electronic device 40, such as a computer or a smartphone, may wirelessly couple with the head-mounted display device 30 and transmit data or information, and the training tasks may be also stored in and displayed on the electronic device 40. A participant 5 may select one of the training tasks to be executed after wearing the head-mounted display device 30 and inputting identifying information on the electronic device 40. Alternatively, when any one of the training tasks is completed, a training record corresponding to the current training task done by the participant 5 may be retrieved to be stored. In one embodiment, the training record includes a task history and answer statistics. The answer statistics, for example but not limited to, includes correct answers and the number of consecutive wrong answers done by the participant for the current training task, and the task history includes various challenge levels and the graphic elements used for the current training task, etc. The system for training visual-spatial cognitive abilities of the present invention may be installed in and executed by the head-mounted display device 30 with excellent processing and storing capacities.

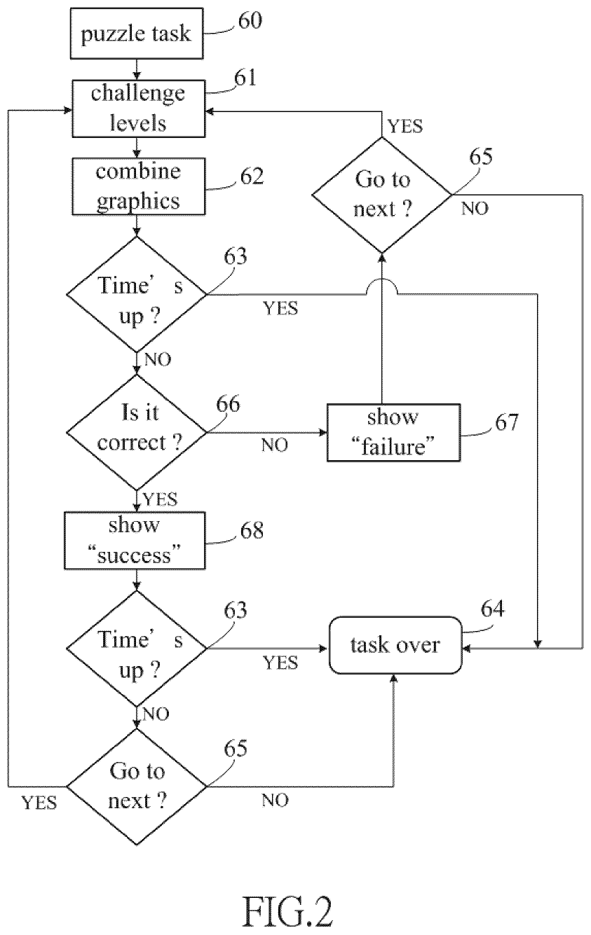

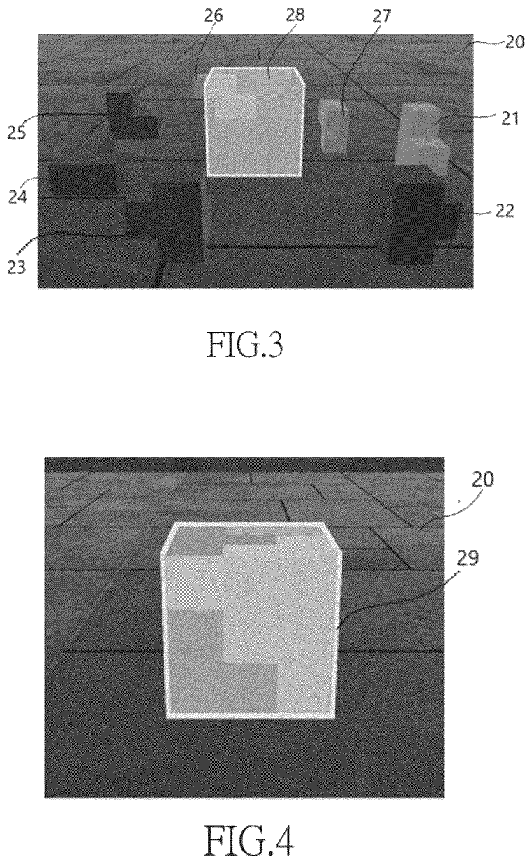

FIG. 2 is a schematical flowchart diagram illustrating a training task implemented by the system for training visual-spatial cognitive abilities in accordance with the present invention. FIG. 3 and FIG. 4 are schematical diagrams illustrating screens from the execution of the training task in FIG. 2. Please refer to FIG. 2, FIG. 3 and FIG. 4. In one embodiment, the puzzle task is selected by the participant (step 60), and then the puzzle task displays and offers multiple challenge levels to the participant for further selection (step 61). Each challenge level includes plural graphic elements 21, 22, 23, 24, 25, 26 and 27 to be dispersed displayed within a scene 20, and a target graphic 28 is also displayed within the scene 20. The participant 5 may control, such as rotate or move, these graphic elements with a suitable input interface to combine them in various way to see whether a combined graphic 29 is the same as the target graphic 28 (step 62). During the participant interacts with the specific challenge level of the puzzle task, the puzzle task compares ongoing time and a preset time (step 63) and determines according to a check-time result whether the current challenge level goes to an end (step 64) or prompts the participant to run continuously or not(step 65). When the ongoing time is not over the preset time, the puzzle task compares the combined graphic and the target graphic to determine whether they are same to form a comparison result (step 66). A failure message (step 67) or success message (step 68) will be shown according to the comparison result. It is understood that the prompting messages for the participant may be word/words, graphic, icon or audio without limitation, to inform the participant the result of challenge level, so “Pass” or “no Pass” shown in figures may be substituted by other word/words.

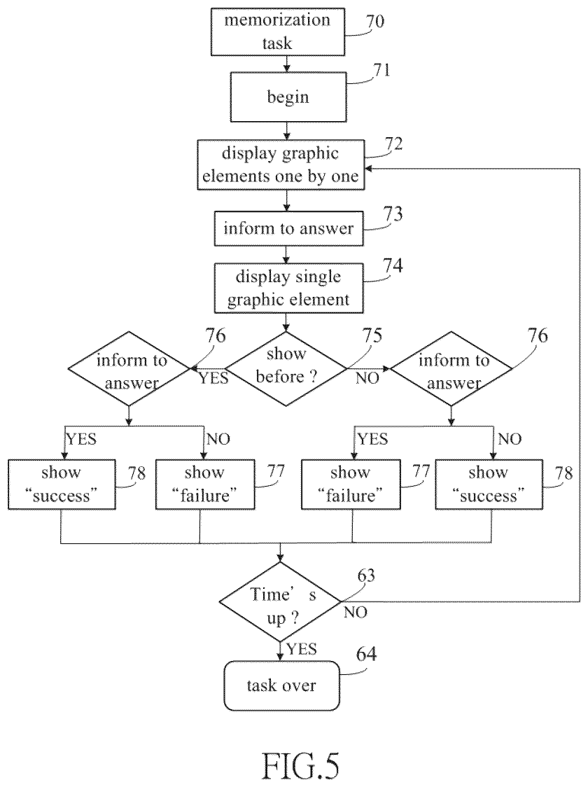

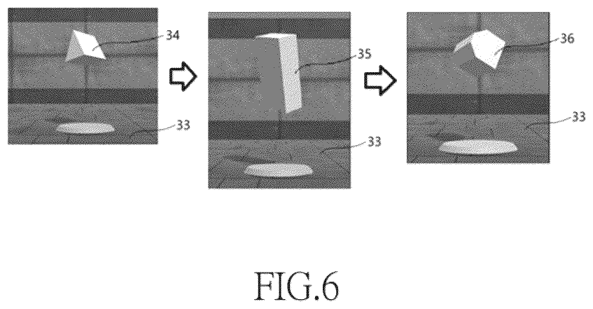

FIG. 5 is a schematical flowchart diagram illustrating a training task implemented by the system for training visual-spatial cognitive abilities in accordance with the present invention. FIG. 6 is a schematical diagram illustrating in-sequence screens from the execution of the training task in FIG. 5. Please refer to FIG. 5 and FIG. 6. In one embodiment, the memorization task is selected by the participant (step 70) to begin (step 71). Multiple graphic elements 34, 35 and 36 will be displayed one by one at certain time intervals (step 72) within a scene 33, and then the memorization task prompts the participant to be ready for answering (step 73). Next, a single graphic element will be displayed (step 74) and be compared whether it is one of the graphic elements 34, 35 and 36 earlier provided by the memorization task (step 75). One message will be displayed to prompt the participant to be ready for answering, too. The after-displayed single graphic element may be or be not one of the graphic elements 34, 35 and 36, and the participant is asked to make a “yes” or “no” answer (step 76). A failure message (step 77) or success message (step 78) will be shown according to the comparison result by the memorization task. Similar to the puzzle task, during the participant interacts with the specific challenge level of the memorization task, the memorization task compares the ongoing time and the preset time (step 63) and determines according to the check-time result whether the current challenge level goes to an end (step 64) or prompts the participant to run continuously or not (step 72). It is understood that the order of step 75 and step 76 may change, that means the prompting step may be followed by the comparison step, and the order of other steps may change for design requirement, too. Furthermore, during the execution of the memorization task, the participant may operate with a suitable input interface to change the viewer's position or the viewed angle of the graphic element to check whether the displayed single graphic element is one of the ones shown previously or not.

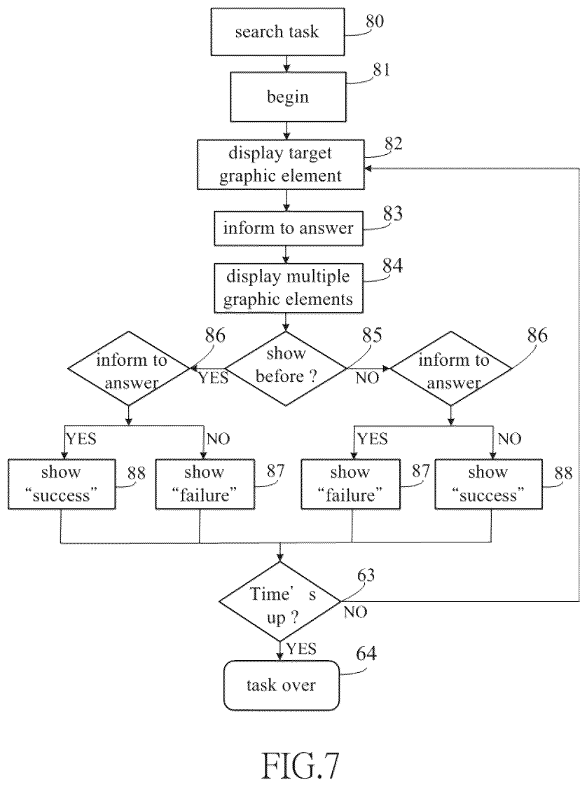

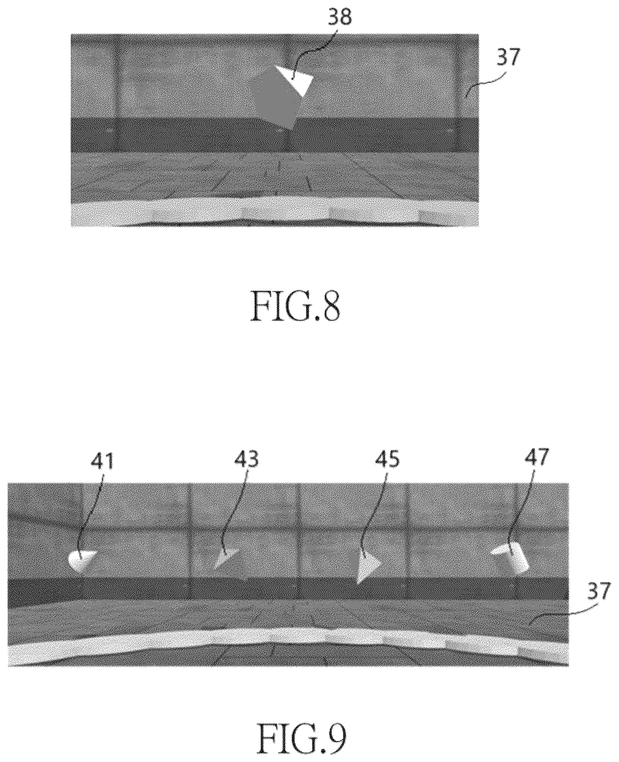

FIG. 7 is a schematical flowchart diagram illustrating a training task implemented by the system for training visual-spatial cognitive abilities in accordance with the present invention. FIG. 8 and FIG. 9 are schematical diagrams illustrating screens from the execution of the training task in FIG. 7. Please refer to FIG. 7, FIG. 8 and FIG. 9, in one embodiment, the search task is selected by the participant (step 80) to begin (step 81). A single target graphic element 38 is displayed in a scene 37 first (step 82), a displayed message prompts the participant to be ready for answering (step 83), and then multiple graphic elements 41, 43, 45 and 47 are displayed simultaneously (step 84). The search task can compare the single target graphic element 38 and the multiple graphic elements 41, 43, 45 and 47 to check whether the single target graphic element 38 is one of the multiple graphic elements 41, 43, 45 and 47 (step 85). And the participant will be asked to answer whether the single target graphic element 38 is one of the multiple graphic elements 41, 43, 45 and 47 (step 86). The answer of the participant may be checked by the search task, and either a failure message (step 87) or success message (step 88) will be determined to be shown according to the comparison result. Similar to the puzzle task, during the participant interacts with the specific challenge level of the search task, the search task compares the ongoing time and the preset time (step 63) and determines according to the check-time result whether the current challenge level goes to an end (step 64) or runs continuously (step 82). Furthermore, during the execution of the search task, the participant may operate with a suitable input interface to check whether the displayed graphic element includes the single target graphic element shown previously or not.

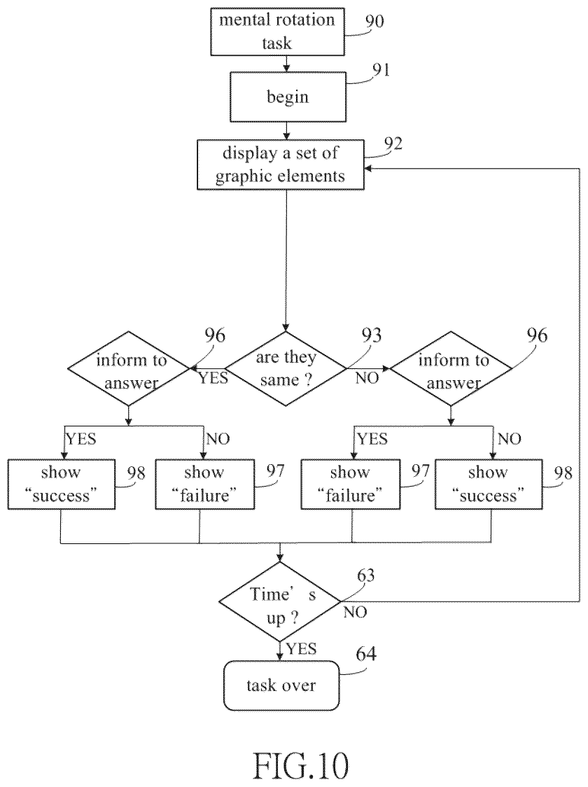

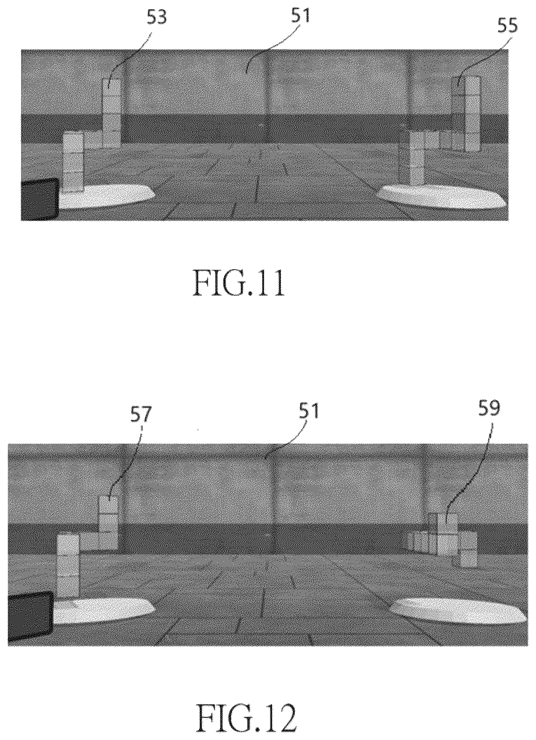

FIG. 10 is a schematical flowchart diagram illustrating a training task implemented by the system for training visual-spatial cognitive abilities in accordance with the present invention. FIG. 11 and FIG. 12 are schematical diagrams illustrating screens from the execution of the training task in FIG. 10. Please refer to FIG. 10, FIG. 11 and FIG. 12, in one embodiment, the mental rotation task is selected by the participant (step 90) to begin(step 91). A first set of graphic elements 53 and 55 or a second set of graphic elements 57 and 59 is displayed within a scene 51 (step 92). The mental rotation task compares the graphic elements in the same set to determine whether they are identical but at different perspective angles or different from each other (step 93). The participant will be informed and asked to determine whether the graphic elements 53 and 55 in the first set or the graphic elements 57 and 59 in the second set are identical to each other. After the participant sends an answer (step 96), the mental rotation task will determine that either a failure message (step 97) or success message (step 98) is shown based on the comparison result of the participant's answer and a judgement in step 93. Similar to the puzzle task, during the participant interacts with the specific challenge level of the memorization task, the mental rotation task compares the ongoing time and the preset time (step 63) and determines according to a check-time result whether the current challenge level goes to an end (step 64) or run next set of graphic elements (step 92). Furthermore, during the execution of the mental rotation task, the participant may operate with a suitable input interface to check whether both displayed graphic elements in the same set are identical to each other or not.

Continuously refer to FIG. 1, the system for training visual-spatial cognitive abilities of the present invention may integrate with other test results for the participant to evaluate the participant's progress. In one embodiment, before and after the participant completes these training tasks, the participant may further do other tests relevant to spatial cognitive abilities, for example, WAIS block design test (WAIS-BDT) or Spatial Reasoning Instrument (SRI) test to respectively acquire a pre-training test result and a post-training test result. It is understood that those other tests relevant to spatial cognitive abilities may be regular paper tests or on-line tests with the electronic device 40 which includes a display panel. Optionally, before and after the participant completes these training tasks, the participant may further do virtual reality (VR) tests relevant to spatial cognitive abilities which include multiple questions in different levels and then respectively acquire a pre-training VR result and a post-training VR result. Accordingly, those pre-or post-training regular or VR results may be used to evaluate the participant's progress with the training tasks of the system for training visual-spatial cognitive abilities of the present invention. Moreover, these training tasks of the present invention may be used to adoptively modify questions in those regular paper tests, on-line tests, VR tests or themselves or both.

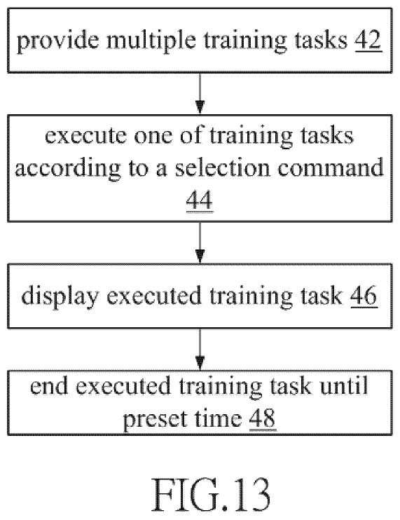

FIG. 13 is a schematical flowchart diagram illustrating the system for training visual-spatial cognitive abilities in accordance with the present invention. The system for training visual-spatial cognitive abilities of the present invention can be stored in a program type in one or more computer-readable media and be computer executable to execute multiple steps thereof. Please refer from FIG. 1 to FIG. 13, the system for training visual-spatial cognitive abilities of the present invention provides the multiple training tasks each of which includes a main script relevant to training of spatial cognitive abilities and at least one three-dimensional (3D) graphic element (step 42). The puzzle task, the memorization task, the search task and the mental rotation task respectively includes its own main script, for example, a main script for tutorial and training relevant to consciousness, composition, manipulation and discourse for the visual-spatial cognitive abilities. One or more 3D graphic elements are selected to collocate with the main script to form the training tasks of the present invention. The main scripts and the accompanying 3D graphic elements may be adaptively changed with the results of other tests to generate different challenging levels of the training tasks. Next, one of the training tasks begins according to a selection command (step 44). As aforementioned, the participant wears the head-mounted display device, inputs personal identifiable information and then selects the appropriate training tasks provided by the system for training visual-spatial cognitive abilities. Optionally, the system for training visual-spatial cognitive abilities may provide the appropriate training tasks based on the information of the participant. Next, one training task being executed will be displayed on the VR display interface (step 46). It is achievable to create diversified materials and scenes in VR immerse environment with help of the head-mounted display device (HMD) to improve the participant's spatial cognitive abilities, so displaying through HMD device is preferred in the present invention. Furthermore, the 3D graphic elements are displayed according to the main script being executed of the selected training task. Next, at least one angle or position of the 3D graphic element shown on the display panel of the HMD device may be changed in response to the participant's input command. Next, the executing training task can end according to the preset time (step 48). Considering the training task for training purpose is different from a game, the training task will be forced until the preset time. It is understood that the executing training task still can be interrupted by the computer through an interrupting command if necessary.

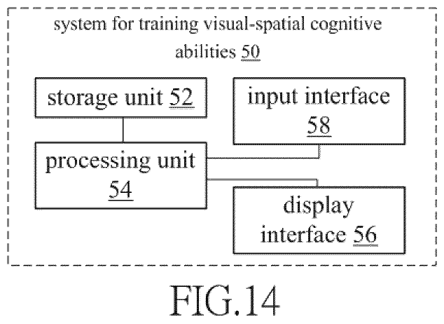

FIG. 14 is a schematically systemic block diagram illustrating the system for training visual-spatial cognitive abilities in accordance with the present invention. Please refer to FIG. 1, FIG. 13 and FIG. 14, the system for training visual-spatial cognitive abilities 50 at least includes a storage unit 52, a processing unit 54 and a display interface 56 wherein the processing unit 54 couples the storage unit 52 and the display interface 56. In one embodiment, the storage unit 52 includes embedded or equipped memory, memory module or memory card for the head-mounted display device 30 or the electronic device 40. In an application scenario with network, the storage unit 52 includes cloud or remote storing device with database. The storage unit 52 stores the plural main scripts and 3D graphic elements both of which are relevant to training of spatial cognitive abilities. The processing unit 54 includes processors, ASIC and peripheral components and circuit of the head-mounted display device 30 or the electronic device 40. In the application scenario with network, includes processors and peripheral circuit of a cloud or remote servo. The processing unit 54 extracts one of the plural main scripts and at least one of the 3D graphic elements to form a training task and execute it within the preset time. In one embodiment, the participant 5 inputs selection command with the input interface 58, such as a keyboard or a mouse of the electronic device 40 or the handheld remote device 32, to select a training task, for example the puzzle task. The processing unit 54 receives the select command from the input interface 58 and extracts the main script and the 3D graphic elements to generate and execute the puzzle task according to the select command. The scene and the graphic elements of the puzzle task are displayed through the output interface 56 for the participant 5. The head-mounted display device 30 is used as a perform interface of executing the training task in the system for training visual-spatial cognitive abilities 50, and the participant 5 views the graphic elements in 3D view angles and interacts with the graphic elements with the input interface 58, such as rotate, move or flip over, etc.

Continuously refer to FIG. 1, FIG. 13 and FIG. 14, during the participant 5 interacts with the specific challenge level of the training task, the processing unit 54 of the system for training visual-spatial cognitive abilities 50 further retrieves how and what the participant 5 answers to form and store a training record for subsequent evaluation. In one embodiment, if other tests relevant to spatial cognitive abilities have been done by the participant 5, the processing unit 54 may, based on test results of the other test, modify the main script and the graphic elements regarding the training task. For example, the participant acquires a better test result after completing several training tasks, and then when the participant would like to do and select one of the training task next time, the processing unit 54 of the system for training visual-spatial cognitive abilities 50 will extract higher level main scripts and more complicating graphic elements to form the training task with higher challenge levels.

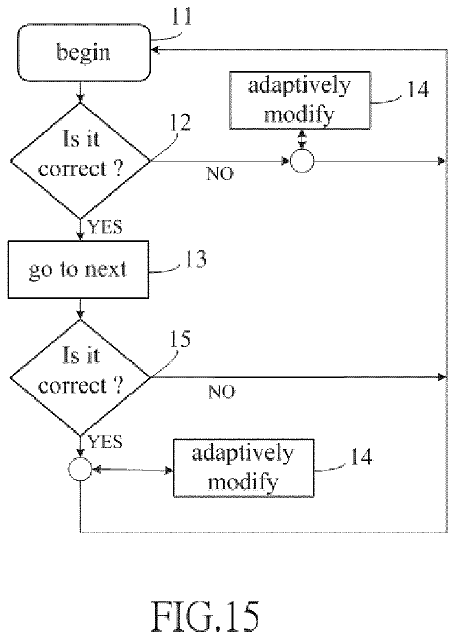

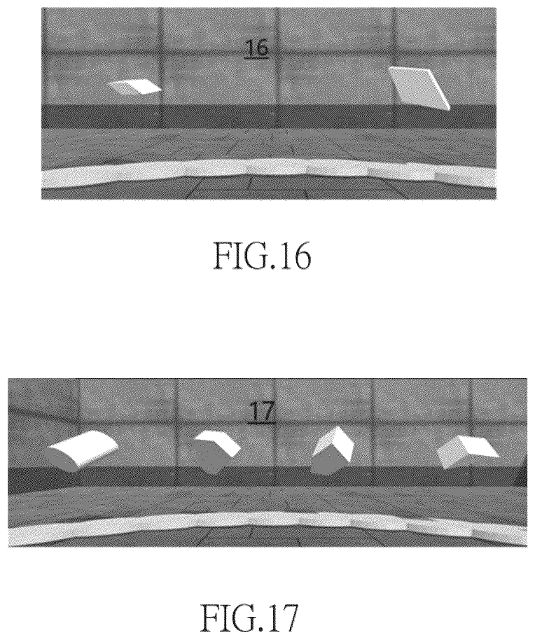

FIG. 15 is a schematical flowchart diagram illustrating a training task implemented by the system for training visual-spatial cognitive abilities in accordance with the present invention. FIG. 16 and FIG. 17 are schematical diagrams illustrating screens from the execution of the training task in FIG. 15. Please refer to FIG. 15, FIG. 16 and FIG. 17, optionally, an auxiliary script and the accompanying graphic elements may be introduced to dynamically modify the challenge levels of the current training task which includes the main script and the graphic elements. In one embodiment, the training task displays questions and asks for the participant to answer (step 11) after beginning, and then determines whether the answers from the participant are correct or not (step 12). If the answer is correct, the participant may go to the next question (step 13) and input an answer for the next question to be further judged (step 15). One of the spirits of the present invention is, when consecutive wrong or correct answers happen, the challenge levels may be adaptively modified by introducing the auxiliary script and the graphic elements (step 14). For example, when the answers consecutively given by the participant are not correct, a screen 16 with fewer numbers of graphic elements will be the next question after modification. When the answers consecutively given by the participant are correct, a screen 17 with more numbers of graphic elements will be the next question after modification. Accordingly, the complexity of the auxiliary script combined with the difficulty and number of the graphic elements may be used to adjust the difficulty degree of a current training task for evaluating the participant's spatial cognitive abilities.

The above description is merely exemplary of the preferred embodiments of the present invention and should not be construed as limiting the scope of the invention. Any modifications, equivalents, substitutions, or improvements made within the spirit and principles of the present invention should be encompassed within the scope of protection of the invention.

What is claimed is:

1. A computer readable storage media, containing computer executable
program to execute following steps comprising:
providing multiple training tasks each of which includes a main script and at least one three-dimensional graphic element, wherein the main script is relevant to training of spatial cognitive abilities;
executing one of the training tasks according to a selection command;
displaying the three-dimensional graphic element of the executed training task on a virtual reality display interface; and
ending the executed training task according to a preset time.

2. The computer readable storage media according to claim 1, further comprising storing a training record in response to the executed training task.

3. The computer readable storage media according to claim 1, further comprising changing at least one of an angle and a position of the three-dimensional graphic element displayed on the virtual reality display interface.

4. The computer readable storage media according to claim 1, wherein the step of providing further provides an auxiliary script of any one of the training task to modify the one training task.

5. A system for training visual-spatial cognitive abilities, comprising:
a storage unit storing multiple main scripts and multiple three-dimensional graphic elements, wherein the main scripts are relevant to training of spatial cognitive abilities;
a processing unit extracting one of the main scripts and at least one of the three-dimensional graphic elements to generate a training task, and executing the training task within a preset time; and
a display interface displaying the three-dimensional graphic element of the executed training task.

6. The system for training visual-spatial cognitive abilities according to claim 5, wherein the processing unit further comprises retrieving a training record in response to the executed training task, and the storage unit further comprises storing the training record.

7. The system for training visual-spatial cognitive abilities according to claim 5, wherein the storage unit further comprises storing at least one auxiliary script, and the processing unit further comprises extracting the auxiliary script to modify the training task.

8. The system for training visual-spatial cognitive abilities according to claim 5, wherein the training task comprises at least one of a puzzle task, a memorization task, a search task and a mental rotation task.

9. The system for training visual-spatial cognitive abilities according to claim 5, wherein the processing unit further comprises, based on a test result relevant to spatial cognitive abilities, extracting one of the main scripts and at least one of the graphic elements to generate the training task.

10. The system for training visual-spatial cognitive abilities according to claim 5, further comprising an input interface electrically coupled to the processing unit, and the processing unit receives a selection command from the input interface to execute the training task.

11. The system for training visual-spatial cognitive abilities according to claim 5, further comprising an input interface electrically coupled to the processing unit, and the processing unit receives an input command to change at least one of an angle and a position of the three-dimensional graphic element displayed on the display interface.

12. A system, comprising:
memory including machine-readable instructions; and
one or more processors configured, in response to executing the machine-readable instructions, to perform operations comprising:
providing multiple training tasks each of which includes a main script and at least one three-dimensional graphic element, wherein the main script is relevant to training of spatial cognitive abilities;
executing one of the training tasks according to a selection command; and
displaying the three-dimensional graphic element of the executed training task on a virtual reality display interface.

13. The system according to claim 12, wherein operations performed by the one or more processors further comprises ending the executed training task according to a preset time.

14. The system according to claim 12, wherein operations performed by the one or more processors further comprises storing a training record in response to the executed training task.

15. The system according to claim 12, wherein operations performed by the one or more processors further comprises changing at least one of an angle and a position of the three-dimensional graphic element displayed on the virtual reality display interface.

16. The system according to claim 12, wherein operations performed by the one or more processors further comprises providing an auxiliary script of any one of the training task to modify the one training task.

17. The system according to claim 12, comprises a head-mounted display device.

18. The system according to claim 12, comprises a head-mounted display device and a computer coupled to each other. System and Method for Training Visual-Spatial Cognitive Abilities
